(19) United States
(12) Patent Application Publication
(10) Pub. No.: US 2011/0004536 A1
(43) Pub. Date: Jan. 6, 2011

(54) ARTICLE VENDING MACHINE AND METHOD FOR AUDITING INVENTORY WHILE ARTICLE VENDING MACHINE REMAINS OPERATIONAL

(75) Inventors: Eric J. Hoersten, Chicago, IL (US); Franz Kuehnrich, Bartlett, IL (US); William E. Caputo, Naperville, IL (US)

Correspondence Address: PATENT ADMINISTRATOR;NEAL, GERBER, & EISENBERG, SUITE 1700, 2 NORTH LASALLE STREET, CHICAGO, IL, 60602, US

(73) Assignee: RedBox Automated Retail, LLC, Oakbrook Terrace, IL (US)

(21) Appl. No.: 12/833,754

(22) Filed: Jul. 9, 2010

Related U.S. Application Data
(63) Continuation of application No. 11/863,909, filed on Sep. 28, 2007, now abandoned.

(51) Int. Cl. G06Q 10/00; B65D 83/00; G06Q 90/00

(52) U.S. Cl. 705/28; 221/199; 705/500

(57) ABSTRACT

An article vending machine capable of performing an inventory audit and automatically pausing the inventory audit in response to a customer transaction request and method for performing the same are shown. After completing the customer request, the article vending machine resumes the inventory auditing process. The article vending machine thereby remains available for customer use during the inventory auditing process.

### CROSS-REFERENCE TO RELATED APPLICATION

This application is continuation application of U.S. patent application Ser. No. 11/863,909, filed on Sep. 28, 2007, entitled “Article Vending Machine and Method for Auditing Inventory While Article Vending Machine Remains Operational,” which is incorporated herein by reference in its entirety.

### TECHNICAL FIELD

The present invention relates to improvements in article dispensing systems and components and methods related to the same. More particularly, the present invention relates to a digital video disc (DVD) distribution system.

### BACKGROUND AND SUMMARY OF THE INVENTION

While the present invention is often described herein with reference to a digital video disc distribution system, an application to which the present invention is advantageously suited, it will be readily apparent that the present invention is not limited to that application and can be employed in article dispensing systems used to distribute a wide variety of dispensable articles.

The digital video disc (DVD) player has been the most successful consumer electronics product launch in history. The market for DVD movie video and video game rentals is enormous and growing. Millions of households have acquired DVDs since they were introduced in 1997. In the first quarter of 2003 alone, it was estimated that well over three million DVD players were shipped to U.S. retailers.

Shipments of movies and music videos on DVD totaled approximately one hundred twenty million discs in the first quarter of 2002. In addition to the foregoing, one of the largest grocery store chains in the United States has reported that DVD movie video and video game rentals are growing at rapid rates in the grocery chain channel of distribution.

In 2003,brick-and-mortar stores dominated the movie video and video game rental landscape in the U.S. Statistics showed that two brick-and-mortar companies control nearly sixty-five percent of the home video rental business. One element repeatedly cited for success of certain brick-and mortar store video rental franchises is perceived high availability of new video releases. Consumers want entertainment on demand, and through stocking multiple units of each new release, successful brick-and-mortar companies meet this consumer demand.

Pay-per-view video services and Internet-based video rental services are also known. Internet based video rental services have been plagued by their inability to meet the demands of consumers for new video releases during peak viewing times, leading to increased customer dissatisfaction. Pay-per-view video services offer only limited selections to viewers during any time period, and cannot be used with portable DVD players, resulting in significantly less rentals per any given period of time.

The foregoing indicates that there is a significant market potential for aligning regular routines of consumers (e.g., shopping, getting coffee or gas or going to a convenience store) with their DVD movie video and video game rental activities.

One improved DVD dispensing machine is disclosed in commonly owned U.S. Pat. No. 7,234,609, which is herein incorporated by reference in its entirety. The invention of the U.S. Pat. No. 7,234,609 and the present invention can function as a DVD dispensing machine-based distribution system that will typically have multiple units of each new release per DVD dispensing machine. The dispensing machines of the U.S. Pat. No. 7,234,609 and the present invention can stock up to two thousand DVDs (movies, games or other entertainment content), making the system competitive with existing brick-and-mortar video rental superstores.

The dispensing machine and system of the U.S. Pat. No. 7,234,609 and the present invention distinguishes itself from such stores by offering major benefits not conventionally offered by such stores, including additional cross-marketing programs (e.g., promotional rentals for a certain amount of dollars spent at the hosting store) and convenience (e.g., open always).

The dispensing machine of the U.S. Pat. No. 7,234,609 and the present invention yields a competitive advantage in the DVD rental marketplace by offering consumers cross- marketing/promotional programs, convenience of selection (e.g., computer-based searches for movies and recommendations based on consumer profiles), and potentially extended hours. The present invention employs a more cost-effective, convenient platform than brick-and-mortar stores. In addition, with the present invention, DVD dispensing machines can be situated in hosting locations having high foot traffic, such as at a popular grocery store, restaurant, drug store, and/or other popular hosting location.

The dispensing machine of the U.S. Pat. No. 7,234,609 and the present invention can be operated at a substantial savings over the costs associated with traditional brick-and-mortar video rental stores. For example, the present invention does not require hourly employees manning the dispensing machines or restocking them with inventories, due to the ability of the article transport storage units to be delivered to/picked up from host locations by third-party delivery services, such as traditional or contracted courier services.

Unlike brick-and-mortar stores, the dispensing machine of the U.S. Pat. No. 7,234,609 and the present invention does not require an on-site store manager because all operational decisions can be made at a centralized location by a management team officed remote from the hosting locations. Unlike brick-and-mortar stores, the dispensing machine of the U.S. Pat. No. 7,234,609 and the present invention does not require significant physical space. Unlike brick-and-mortar stores, the dispensing machine of the U.S. Pat. No. 7,234,609 and the present invention has low operating costs because no heating or air conditioning is required for the dispensing machines and they consume a relatively low level of electrical energy. In addition, the dispensing machine of the U.S. Pat. No. 7,234,609 has low maintenance costs and downtime.

The dispensing machine of the U.S. Pat. No. 7,234,609 and the present invention addresses the shortcomings of traditional brick-and-mortar stores in a convenient and cost-effective delivery vehicle having the added bonus of serving as an effective promotional platform that drives incremental sales to hosting locations. In addition, the dispensing machine of the U.S. Pat. No. 7,234,609 and the present invention overcomes these disadvantages by at least offering more new releases and older selections for any given time period, and lower cost per viewing with significantly more convenience than Internet-based and pay-per-view services.

The dispensing machine of the U.S. Pat. No. 7,234,609 and the present invention is a fully automated, integrated DVD movie video and video game rental and/or purchase systems. It preferably incorporates robust, secure, scalable software that provides a fully personalized user experience and real-time feedback to hosting locations and advertisers, scalable hardware that leverages existing technologies such as touch screen, focused audio speakers and plasma video monitors, technology utilizing the Internet through a system website, and an article transport storage unit that facilitates the exchange of new DVDs for old DVDs in each machine with virtually no need for human intervention. These technologies and others fill long-felt needs in the art and give advantages over conventional video distribution options. The dispensing machine of the U.S. Pat. No. 7,234,609 and the present invention functions as much as a promotional platform as it does a rental kiosk.

By utilizing the dispensing machines and the fully-interactive, real-time, linked Internet website, consumers can rent one or more DVD movie videos, video games, or other entertainment content directly from dispensing machines as well as indirectly by making a rental reservation through the website for later pickup at a conveniently located machine. These dispensing machines are preferably networked with each other, with the inventory control and/or supply office and with the system website by phone-line, DSL, or other internet connection at each hosting location. Through this linked network, the rental experience for each consumer can be customized based on a profile for each consumer, such as via personalized home pages and rental screens.

Another benefit of the dispensing machine of the U.S. Pat. No. 7,234,609 and the present invention is that it can provide a method for automated inventory control so that electronic data records can be kept related to inventory control for each dispensing machine within a network of such machines.

However, despite the automatic inventory tracking capabilities of these dispensing machines, it is useful for these machines to be able to perform an inventory auditing process to verify the inventory of the machine. During an inventory auditing process, the machine reads the information coded on each article and may correlate that information to the location of the article within the machine. The correlation of the article and its location are stored in a database. Such an inventory auditing process is also useful if the stored inventory data is lost or damaged. Such an inventory auditing process may also be used when a large portion of the machine inventory is changed out. Prior inventory auditing processes rendered the machine unusable to customers because the components used for customer transactions were the same components used for the inventory auditing process. Specifically, for example, a scanner, selector arm, a processor and a database are used during the inventory audit and are also used during customer rental, purchase, and return of articles. At least some of these same components were needed for customer transactions and, therefore, when the machine was performing an inventory audit, a customer would be unable to use the machine.

The present invention permits a customer to perform a transaction such as a rental, purchase or return while the inventory auditing process is being performed. This permits the inventory auditing process to be performed at any time without limiting the hours of operation of the machine and without lost sales and dissatisfied customers who are unable to use the machine while it performs an inventory audit.

Thus, the present invention is directed to a method and apparatus for a DVD dispensing machine that permits the machine to perform a customer transaction while the machine performs an inventory audit. In one embodiment, the method includes the initiation of the inventory auditing process. The initiation of the inventory audit process may occur either automatically or manually via a request from an administrator. The inventory auditing process is controlled by a computer program and, thus, initiation of the inventory auditing process comprises initiation of the computer program and method therein. The computer program may be run as a background program or may be run on a partitioned operating system or other automated arrangement, thereby permitting a customer to interact with the machine operating system and allowing the processor to perform various routines while it runs the inventory auditing program.

During the inventory auditing process a selector arm located in the machine and having a first sensor attached to it is positioned adjacent a plurality of storage compartments located within the machine. At each storage compartment, the first sensor detects the presence or absence of an article in the storage compartment. If an article is present, the article is removed from the compartment by a picker. The picker then aligns a code on the article with a second sensor that reads information from the code. The information from the code is transferred to a database along with information relating to the location of the storage compartment. If, on the other hand, no article is present in a storage compartment, that information is transferred to the database with the location of the storage compartment. Alternatively, the information from the article and the location of the storage bin may be compared to the values in a pre-existing database, thereby verifying the accuracy of the pre-existing database. After the information is read for one compartment, the selector arm is aligned with the next compartment. The article or lack thereof in each compartment is read by the first sensor until the process is stopped or until all compartments have been checked/read.

During the inventory auditing process, a user interface such as a touch screen or keypad remains available for use by a customer. Using the user interface, a customer may initiate a transaction that requires the use of the sensor and selector arm, such as a video rental, purchase or return. In response to the requested transaction, the computer pauses the inventory audit program. The various components of the machine perform the transaction requested by the user, which may require the sensor to read information from the returned or requested video and may further require transport of the returned or requested video.

When the transaction is completed, the inventory auditing process is resumed. The inventory audit program resumes at the point at which it paused and continues to scan each compartment until completion of the program.

### BRIEF DESCRIPTION OF THE DRAWINGS

FIG. 1 is an illustration of a system for communicating and processing information in a network of article vending machines and vending apparatus;

FIG. 2 is a perspective view of an article dispensing machine constructed in accordance with the principles of the present invention;

FIG. 3 is a partially open perspective view of the article dispensing machine of FIG. 2;

FIG. 4 is a partially open side elevational view of the article dispensing machine of FIG. 2;

FIG. 5 is a partially open side elevational view of the view of the article dispensing machine of FIG. 2 with certain components removed for clarity;

FIG. 6 is a flowchart illustrating an order of operations performed by an article dispensing machine for auditing the inventory of the article dispensing machine.

FIG. 7 is a flowchart illustrating an order of operations performed by an article dispensing machine for servicing a requested transaction during the inventory auditing operation of FIG. 6.

FIG. 8 is a flowchart illustrating of an order of operations performed by an article dispensing machine for aligning a selector arm with an article.

### DETAILED DESCRIPTION OF THE INVENTION

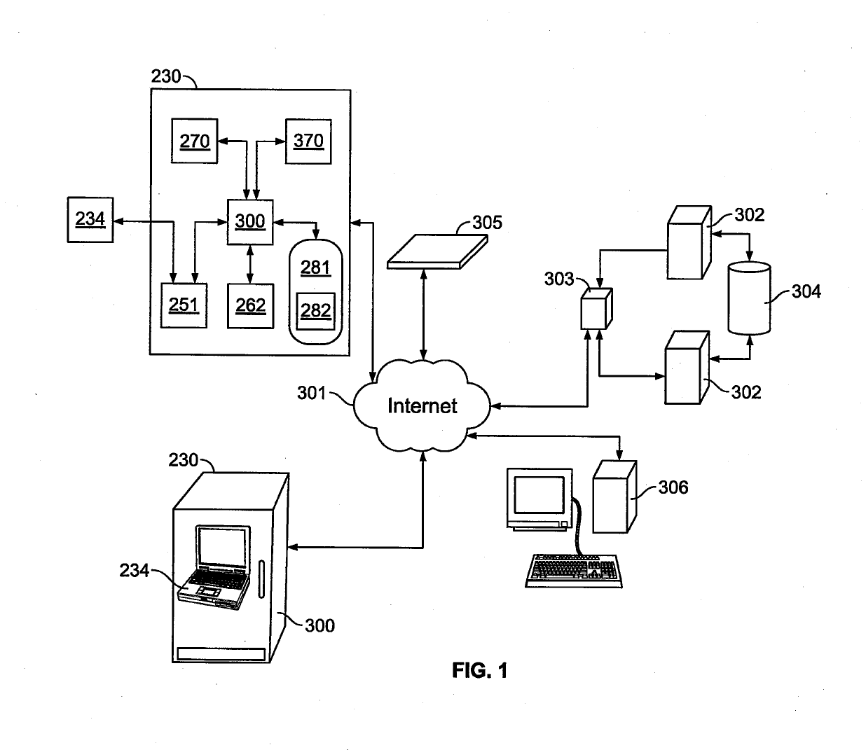

FIGS. 1-5 illustrate an article dispensing machine generally designated 230. Article dispensing machine 230 is one of a plurality of article dispensing machines included within an article distribution system having a plurality of such machines situated at a plurality of hosting locations. The article dispensing machines of a particular article distribution system preferably form a network. As such, those machines are preferably in electrical communication with each other and with a central server or central controller.

As shown in FIG. 1, each article dispensing machine 230 includes a dispensing machine processor 300, also referred to herein as a vending controller, which is connected to a first sensor 270 and second a second sensor 370, a first motor 251 and a second motor 262 and a user interface control system 234, collectively referred to as “the peripheral devices.” The processor is capable of executing various programs to provide input to and receive outputs from the peripheral devices. Suitable processors for such use are known to those of skill in the art. In addition, the processor is operably connected to at least one memory storage device 281, such as a hard-drive or flash-drive or other suitable memory storage device.

Article dispensing machine memory storage device 281 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, article dispensing machine memory storage device 281 may incorporate electronic, magnetic, optical, and/or other types of storage media. Article dispensing machine memory storage device 281 can have a distributed architecture where various components are situated remote from one another, but are still accessed by processor. Article dispensing machine memory storage device includes an article dispensing machine database 282. Article dispensing machine database 282 stores information regarding, among other things, the inventory of the article dispensing machine including the position of each article within the inventory of the article dispensing machine.

The article dispensing machines 230 preferably comprise a network of machines in communication with one another. As shown in FIG. 1, in the preferred configuration, the machines are networked with one another via a central server or central controller 302 in a hub-and-spoke system. However, optionally, the article dispensing machines may be connected and communicate directly with one another.

Generally, in terms of hardware architecture the central server 302 includes a central processor and/or controller, central memory, and one or more input and/or output (I/O) devices (or peripherals) that are communicatively coupled via a local interface. The architecture of the central server is set forth in greater detail in U.S. Pat. No. 7,234,609, the contents of which are incorporated herein in their entirety. Numerous variations of the architecture of the central server would be obvious to one of skill in the art and are encompassed within the scope of the invention set forth herein.

Steps and/or elements, and/or portions thereof of the present invention may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the operating system (O/S). Furthermore, the software embodying the present invention can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. frequency (RF) or other transceiver, a telephonic interface, a bridge, and a router.

When article dispensing machine 230 is in operation, the article dispensing machine processor is configured to execute software stored within article dispensing machine memory, to communicate data to and from memory, and to generally control operations of article dispensing machine pursuant to the software. The present invention and the O/S, in whole or in part, but typically the latter, are read by processor, perhaps buffered within the processor, and then executed.

When the present invention is implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read- only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

For communication with the central server 302, article dispensing machine 230 is equipped with network communication equipment and circuitry. In a preferred embodiment, the network communication equipment includes a network card such as an Ethernet card. In a preferred network environment, each of the plurality of article dispensing machines 230 on the network is configured to use the TCP/IP protocol to communicate via the network 301. It will be understood, however, that a variety of network protocols could also be employed, such as IPX/SPX, Netware, PPP and others. It will also be understood that while a preferred embodiment of the present invention is for article dispensing machine 230 to have a “broadband” connection to the network 301, the principles of the present invention are also practicable with a dialup connection using a standard modem. Wireless network connections are also contemplated, such as wireless Ethernet, satellite, infrared and radio frequency networks.

The central controller 302 is responsible for communicating with the article dispensing machine controller 300 via the network 301. The central controller 302 is preferably located at a central station that is remote from the plurality of article dispensing machines 230. The central controller 302 operates as the server for communicating over the network 301 between the plurality of article dispensing machines 230. The central controller 302 receives communication from the article dispensing machines 230, and also transmits information to the machines 230. For example, when a DVD rental transaction is performed at the article dispensing machine 230, transaction data such as the rented DVD title is then transmitted from the machine 230 to the central controller 302 via the network 301. It will be understood that central servers in general, such as the central controller 302, are often distributed. A plurality of central controllers 302 may optionally be arranged in a “load balanced” architecture to improve the speed and efficiency of the network. To accomplish the implementation of multiple controllers 302, the controllers 302 may be in communication with a router/distributor 303.

The central controller 302 is in communication with a central database 304. The central database 304 stores information regarding the transaction network. For example, the central database 304 stores data regarding the vending inventory at each of the plurality of article dispensing machines 230. The central database 304 also stores sales information regarding the sales quantities of the vending merchandise stored in the machines 230. For example, the central database 304 stores information regarding the sales totals for each DVD title and for each machine 230 vending location. Central database 304 also stores user information and rental transaction information, such as user IDs, PINs, the date on which DVDs are due to be returned and the date on which DVDs were rented from the machines 230. Such information is also preferably stored in article dispensing machine database 282.

Central database 304 is preferably a relational database, although other types of database architectures may be used without departing from the principles of the present invention. For example, database 304 may be a SQL database, an Access database or an Oracle database, and in any such embodiment have the functionality stored herein. Central database 304 is also preferably capable of being shared, as illustrated, between a plurality of central controllers 302 and its information is also preferably capable of being transmitted via network 301. It will be understood that a variety of methods exist for serving the information stored in central database 304. In a preferred embodiment, .net and Microsoft Reporting Services are employed, however, other technologies such as ODBC, MySQL, CFML and the like may be used.

The central controller 302 and central database 304 are also preferably accessible by a personal computer 306. The personal computer 306 will be understood as comprising hardware and software consistent with marketable personal computers, such as a display monitor, a keyboard and mouse and a microprocessor. The personal computer also comprises Internet browser software such as Firefox or Internet Explorer. Using the browser software, a user at the personal computer 306 can access a web interface through the central controller 302. To that end, central controller 302 preferably comprises web server software such as IIS or Apache. It will be understood that a variety of web server software and web browser software exists to implement the principles of the present invention without departing therefrom. Through the web browser software, the personal computer 306 communicates with the central controller 302 and allows the user to login to a central command functionality of the central controller 302 and to view and modify data stored in the central database 304. The browser interface also allows the user to perform certain system functions, which will affect the inventory and behavior of the article dispensing machines 230.

In a preferred embodiment, a financial server 305 is also in communication with the network 301. It will be understood that a variety of financial services exist for processing financial information via the Internet and other networks 301. Those services allow for the processing of credit card and debit card information, so that users of the services do not have to interface directly with credit and debit card companies. In FIG. 1, the financial server 305 is illustrated as a single server, although the financial server 305 may comprise an entire sub-network of financial servers 305 responsible for processing financial information.

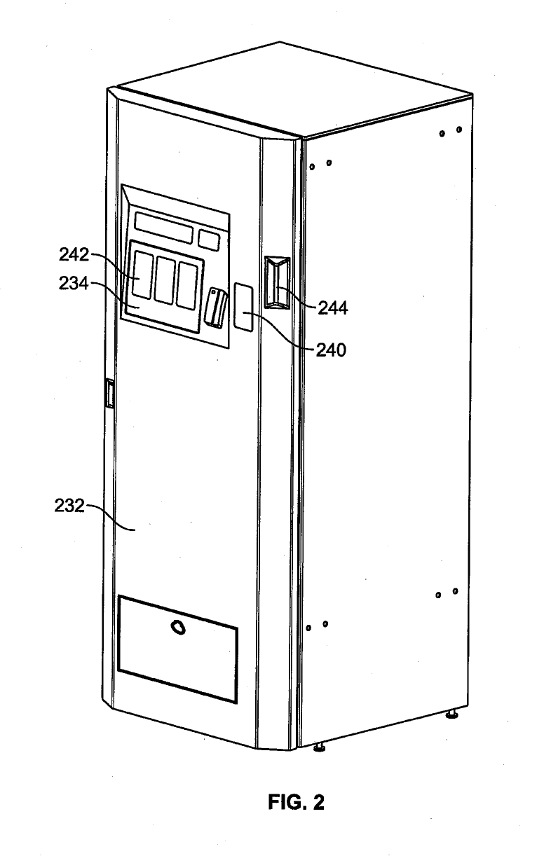

As shown in FIG. 2, article dispensing machine 230 includes a machine housing 232 with front, rear, top, bottom and side panels. The machine housing 232 is preferably a combination molded fiberglass and sheet metal cabinet. However, those skilled in the art will appreciate that the housing can be constructed from a variety of other suitable materials and with a variety of other suitable manufacturing techniques.

As shown most clearly in FIG. 2, a user interface portion 234 of housing 232 includes a card reader 240, a keypad and/or touch screen 242 and an article transfer opening 244. The card reader 240 is preferably designed in known fashion to read magnetically encoded membership and/or credit cards for authorizing the distribution of articles of inventory through the article transfer opening 244. Keypad and/or touch screen 242 permits consumers and/or inventory stocking personnel to communicate with the dispensing machine 230 and/or a central office linked in electrical communication with the dispensing machine. Keypad and/or touch screen 242 also permits consumers and/or inventory stocking personnel to enter appropriate commands directed to carrying out specific machine tasks. It will be appreciated that the optional touch screen includes a monitor made with known technologies making it capable of being utilized as a user interface for entry of commands designed to carry out machine tasks.

Furthermore, it will be appreciated that additional user interface portions having additional or even identical user interface components could be incorporated within article dispensing machine 230. For example, these components could be incorporated on other panels of the housing 232 of machine 230 so that the machine can be used simultaneously by multiple consumers, translating into more efficient distribution of articles in high traffic areas.

Dispensing machine 230 also preferably includes speaker units 246. Preferably, known audio technology is incorporated within dispensing machine 230 to broadcast focused audio directed to relatively small (e.g., three square feet) locations in front of the machines from speaker units 246 and/or in other designated locations at a hosting site.

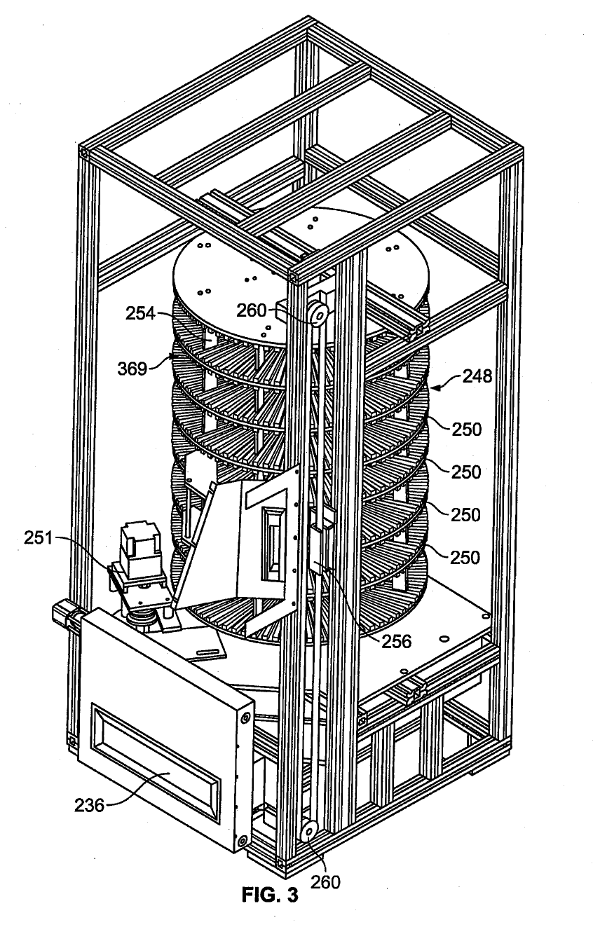

Referring now to FIG. 3 which shows the components positioned in the interior of dispensing machine 230, the article dispensing machine includes a storage device 248 which is a carousel-style, cylindrical storage facility having a plurality of compartmentalized rows 249 defined by circular-shaped storage racks 250 sharing a common central axis. Each of the rows 249 has a plurality of compartments 369. Each storage rack 250 includes radially extending, angularly separated compartment panels defining article storage compartments 369 which are designed to receive and retain flat-type pack articles, such as DVD cases, as desired. The compartment panels are preferably axially aligned to retain the opposing sides of DVD cases at the top and bottom ends thereof. In that regard, the DVD cases are preferably retained between successive vertical pairs of storage racks 250. The storage racks 250 are vertically spaced by axially extending support members 254.

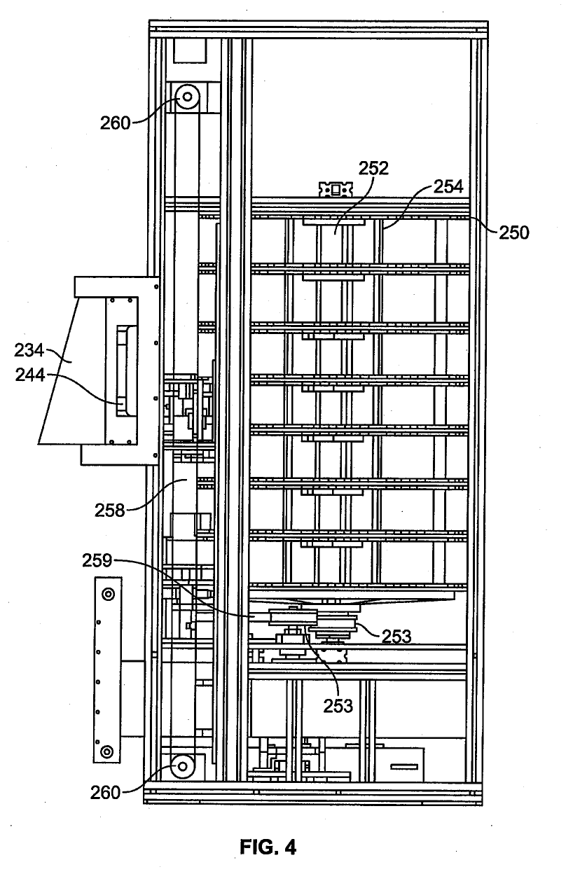

A first motor 251, hereinafter referred to as the rotational motor, rotates the storage device 248 about a vertical axis formed by the driven shaft 252. As shown in FIG. 4, rotational motor 251 drives a belt 259, which in turn rotates wheels 253 and shaft 252 to which the storage racks 250 are attached.

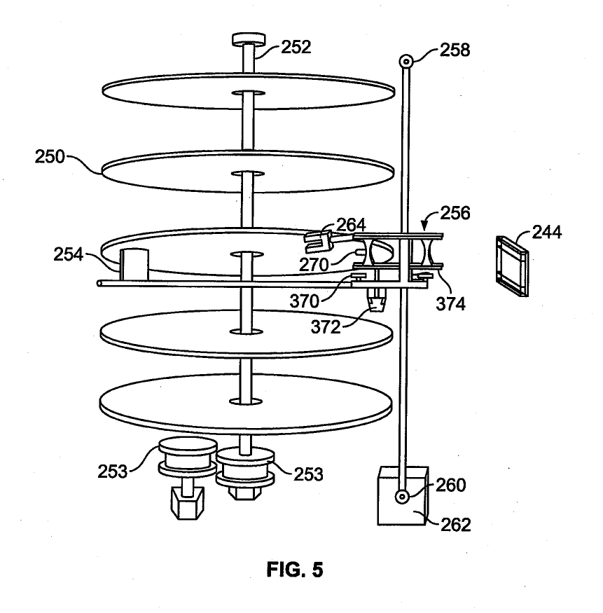

As shown in FIGS. 3 and 5, a selector arm 256 is adjacent the storage device 248. The selector arm 256 is connected to a conveying belt 258 carried by rollers 260, which are preferably positioned proximate to the top and the bottom of the article dispensing machine housing. At least one of the rollers 260 may be driven by a second motor 262, hereinafter referred to as the selector arm motor, to provide for vertical movement of selector arm 256 along a vertical axis generally parallel to the vertical axis of the storage device. Alternatively, the selector arm motor 262 may be positioned on the selector arm 256. In a preferred embodiment, the motors 251, 262 are stepper motors that are capable of accurately controlling the movement and position of the compartmentalized storage device 248 and the selector ann 256, respectively.

Referring now to FIG. 5, the vending apparatus 230 is equipped with a first sensor 270 for sensing objects stored in the inventory of the apparatus. The first sensor is preferably mounted on the selector arm 256. A variety of forms of sensors are practicable with the present invention for use as the first sensor without departing from the principles thereof, including proximity sensors, proximity sensors, an optical laser scanner, a magnetic scanner, an optical bar code reader, an ultraviolet optical scanner, a radio frequency sensor and an infrared optical scanner. The vending apparatus 230 is further equipped with a second sensor 370 capable of reading information attached to the objects stored in the inventory of the apparatus. The second sensor 370 is preferably, as illustrated, mounted on the selector arm 256. A variety of forms of sensors are practicable with the present invention for use as the second sensor without departing from the principles thereof, including an optical laser scanner, a magnetic scanner, an optical bar code reader, an ultraviolet optical scanner, a radio frequency sensor and an infrared optical scanner.

The selector arm 256 comprises a picker device 264 which is capable of removing a DVD from the compartments 369. The selector arm 256 may further comprise a conveyor belt 374, which contacts one of the media products in one of the compartments 369 and conveys the product to the article transfer opening 244 whereby it is delivered to a user on the exterior of the article dispensing machine 230. The conveyor 374 is driven by a conveyor motor 372.

A system and method for calibrating the selector arm controller is disclosed in commonly owned U.S. Patent Application, Publication No. 2006/0254832, which is herein incorporated by reference in its entirety.

Generally, during the normal operation of the article dispensing machine, each article of inventory dispensed from a dispensing machine is preferably scanned by the second sensor 370 and an electronic record is created indicating the consumer who rented and/or purchased the media. In addition, articles of inventory returned to a dispensing machine by a customer and inserted into the article transfer opening 244 thereof are preferably scanned by the second sensor 370 and identified by the dispensing machine (for example with a bar code reader or scanner in electronic communication with the dispensing machine controller, positioned proximate the media dispending/return opening) along with an identification of its later stored position on the storage device.

These electronic records can be shared among dispensing machines within a network thereof, and can also be shared with a centralized office via the Internet or any other electronic data communication link. These electronic records can be used to ensure that the inventory process is carried out efficiently and accurately.

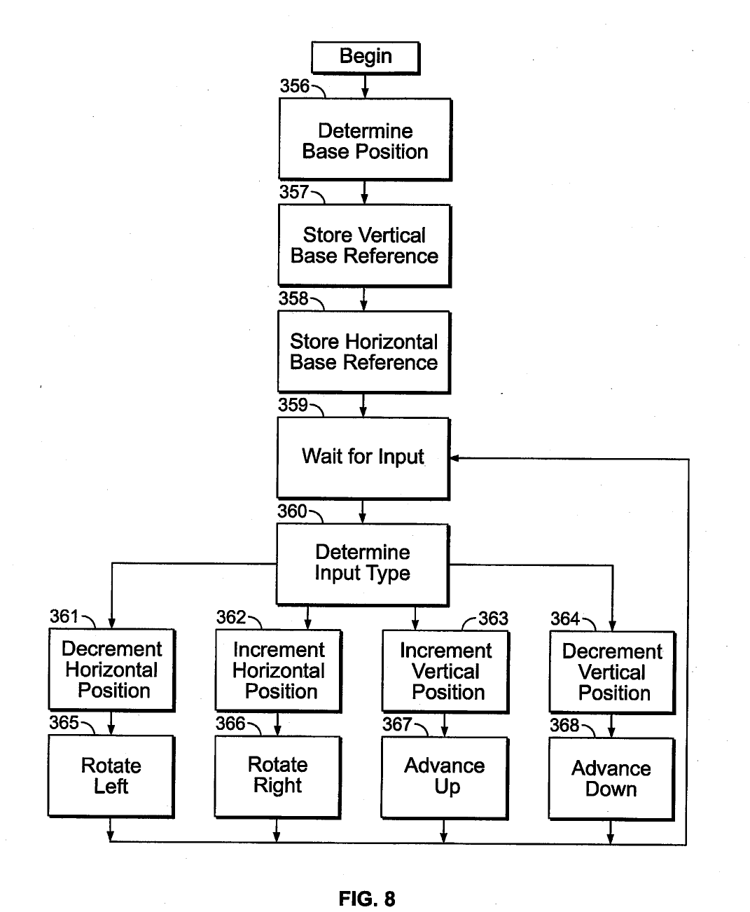

A method of positioning the selector arm in front of a storage compartment 369 as shown in FIG. 8 follows. In one embodiment, the vending controller 300 analyzes the coordinates of a vending product stored within one of the storage compartments 369. The coordinates comprise a vertical coordinate and a horizontal coordinate (or a vertical coordinate and angular coordinate), wherein the vertical coordinate refers to one of the plurality of rows 249 and the horizontal component refers to one of the compartments 369 within that row 249. A first base position is determined 356 and a vertical base reference 357 and a horizontal base reference 358 are stored. The controller then waits for input as shown in step 359. The controller 300 analyzes the vertical coordinate of the new coordinate pair to the vertical coordinate of the present position to determine whether to advance the selector arm 256 up or down along the vertical axis. If the vertical coordinate is greater than the present vertical base reference position of the selector arm 256, as determined in step 367, the controller 300 instructs the motor 262 to advance the selector arm 256 in an “up” direction along the vertical axis, as illustrated in step 363. If the vertical coordinate is less than the present vertical base reference position of the selector arm 256, as determined in step 368, the controller 300 instructs the motor 262 to advance the selector arm 256 in a “down” direction along the vertical axis, as illustrated in step 364. If the vertical coordinate is the same as the present vertical base reference position, no action is taken. Thus, the selector arm 256 is positioned at the vertical coordinate received from the controller 300 wherein the vertical coordinate refers to one of the plurality of compartmentalized rows 249.

The controller 300 also analyzes the horizontal coordinate of the coordinate pair, wherein the horizontal coordinate refers to one of the storage compartments 369 in one of the rows 249. If the horizontal coordinate is greater than the present horizontal base reference position of the selector arm 256, as determined in step 366, the controller 300 instructs the motor 251 to rotate the storage device 248 in a clockwise direction, as illustrated in step 362. If, however, the horizontal coordinate is less than the present horizontal base reference position of the selector arm 256, as determined in step 365, the controller 300 instructs the motor 251 to rotate the storage device 248 in a counterclockwise direction, as illustrated in step 361. If, however, the horizontal coordinate is equal to the present horizontal base reference position, the storage device 248 is not rotated. Thus, after the rotation is complete, the selector arm 256 will be aligned with the storage compartment 369 corresponding to the coordinate pair.

It will be understood that a motor 251 capable of rotating in a single direction (i.e., clockwise or counter-clockwise) is practicable with the present invention, because the storage device 248 is cylindrical. In particular, if the horizontal coordinate of the coordinate pair is less than the present horizontal base reference position of the selector arm 256, the controller 300 can instruct the motor 251 to rotate the storage device 248 clockwise until the selector arm 256 is aligned with the correct compartment 369. Thus, either a unidirectional or bidirectional motor 251 can be used to rotate the storage device 248.

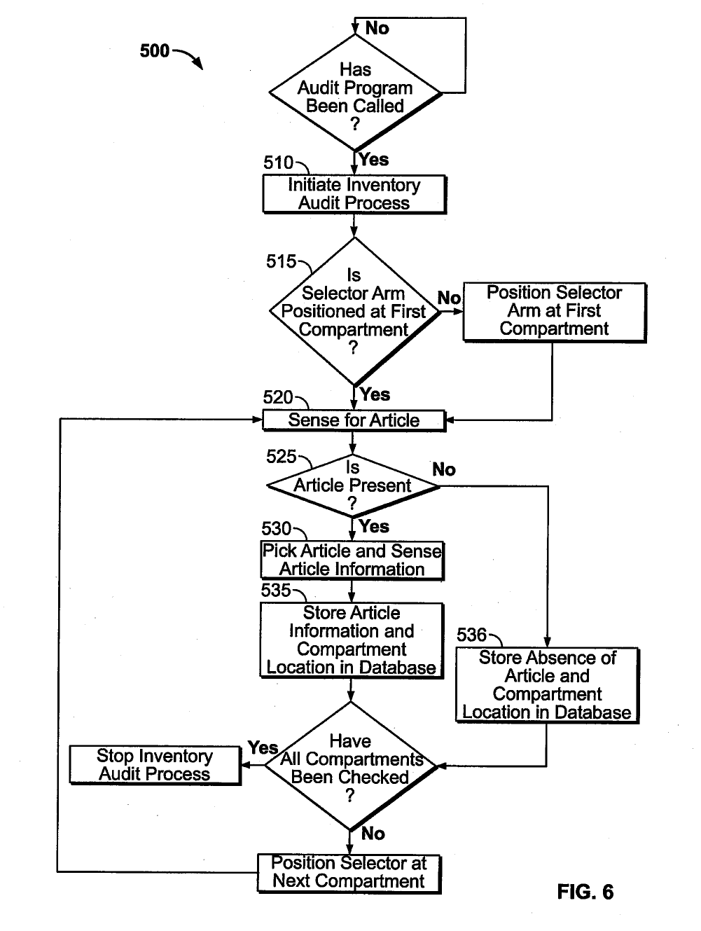

The inventory auditing process 500 is shown in FIG. 6. Initiation 510 of the inventory audit process may be triggered automatically based on a number of conditions. For example, a separate scheduling program may call the inventory audit program at a certain time each day or at a certain time and day of each week. Alternatively, a separate program may call the inventory audit program after a certain number of service hours have passed or after a certain number of transactions have occurred. In addition, the inventory audit process could be initiated by a number of conditions. For example, the program may be automatically initiated a specified amount of time after a system restart or a set amount of time after a power loss and subsequent power restoration by a restart program. Initiation may also be set to occur automatically after restocking of the machine by a restocking program. Furthermore, initiation may occur manually, for example, by a request from an administrator or a request from a central processor to which the article vending machine is networked.

The inventory auditing process is controlled by an inventory auditing computer program and, thus, initiation of the inventory auditing process comprises the article dispensing machine processor 300 beginning the inventory auditing computer program which may be stored in the article dispensing machine memory 281. The inventory auditing computer program may be run as a background program or may be run on a partitioned operating system, thereby permitting a customer to interact with the machine operating system and allowing the article dispensing machine processor to perform various routines while the article dispensing machine processor runs the inventory auditing program.

As shown in step 515, the inventory auditing program determines whether selector arm 256 is positioned at a designated first compartment based on the coordinates of the selector arm. If the selector arm is at the first compartment, no action is taken. However, if the selector arm is not at the first compartment, the inventory auditing program directs the processor to generate signals to rotational motor 251, which drives the rotation of the storage device 248, and selector arm motor 262, which adjusts the vertical position of the selector arm 256, to position the selector arm 256 relative to the first storage compartment.

As shown in step 520, after the selector arm 256 is positioned adjacent the storage compartment 369, the code, via the processor 300, generates a signal to the first sensor 270, which is preferably located on the selector arm 256, instructing the first sensor to sense for the presence or absence of an article in the storage compartment 369. The first sensor 220 returns a signal to the controller 300 indicating whether or not an article is present in the storage compartment 369. If the first sensor 270 detects the presence of an article and the processor 300 receives such a signal, the article inventory program instructs the processor 300 to generate a signal for the picker 264 to remove the article from the compartment 369, as shown in steps 525 and 530. The program code, as executed by the processor 300 instructs the picker 264 to align the article with the second sensor 370, which may be an optical camera or other sensor capable of reading a bar-code or other information located on the article. A third sensor or set of sensors 375, in communication with the processor 300, may be used to position the article in front of the second sensor 370. The information on the article may include the type of article, for example, the title of a DVD, and/or may include a unique identifier for the article. This information may be contained in a code such as a bar code. The information on the bar code is read by the second sensor 370 and transferred to the processor 300, which stores the information in a database 282 stored in the article dispensing machine memory 281. After the controller 300 has received the information from the second sensor 370, the inventory auditing program instructs the controller to generate signals to the picker 264 to cause the picker to return the article to the storage compartment 369.

The location of the compartment/article is determined based on the positional information of the motors 262 and 251, which control the position of the selector arm 256 and the storage device 248, respectively. As described above in greater detail, motors 251, 262 are preferably stepper motors that are capable of accurately controlling the movement and position of the compartmentalized storage device and the selector arm, respectively. Thus, the actuation of motor 251 or 262 by vending controller 300 may be correlated to the position of the storage compartment 369 within the storage device 248 and recorded as a set of coordinates. In this manner, the position of the storage compartment may be determined and the position of the article may also be transferred to the article dispensing machine database 282 along with information read from the article as shown in step 535.

If the first sensor 270 detects that no article is present in a storage compartment 369, the first sensor generates a signal to the processor 300 indicating that no article is present. The inventory auditing program then instructs the processor 300 to store the absence of the article along with the location of the storage compartment in the article dispensing machine database 282, as shown in step 536. Alternatively, the inventory auditing program may instruct the processor to compare the information read from the article and the location of the storage bin to the values that were already stored in the article dispensing machine database 282, thereby verifying the accuracy of the article dispensing machine database.

After the information is read from the article located in one storage compartment 248 or the lack of article in the storage compartment is detected and the position of the storage compartment is stored in the article dispensing machine database 282, the inventory auditing program sends a signal to actuate the rotational motor 251 to align the selector arm 256 with the next horizontally adjacent compartment. For example, the rotational motor 251 rotates the storage device 248 so that the selector arm 256 is aligned with the compartment adjacent to the compartment that was most recently audited. The inventory auditing program then returns to step 520 and instructs the first sensor 270 to detect the presence of an article, and if an article is present, the picker 264 to pick the article, and stores the information read from the article.

This process may be repeated until each compartment on the row is checked, at which point, the program instructs selector arm motor 262 to raise or lower the selector arm 256 to begin sensing the compartments in a vertically adjacent row of storage compartments. The program then continues to repeat the article detection, picking and reading steps until all compartments have been checked or until the process has been stopped in another manner.

In an alternative embodiment, instead of incrementally advancing the storage device from one compartment to the next adjacent compartment, the program may send a signal to actuate the rotational motor 251 at a constant speed such that it steadily turns the storage device 248. In this configuration, the inventory auditing program directs the first sensor 270 to continuously sense for the presence of an article. When the first sensor detects the presence of an article in a storage compartment 369, it transmits this signal to the controller, which instructs the rotational motor 251 to stop the rotation of the storage device 248 to allow the picker 264 to remove the article from the storage compartment 369.

Turning now to the functioning of the machine during a consumer transaction, as a consumer approaches an article dispensing machine, the consumer observes the display monitor and the user interface 234. The consumer may also observe a plasma/LCD monitor displaying marketing information, or a lightbox containing marketing information for branding the vending apparatus 230. The consumer then enters the appropriate commands at the user interface control 234 associated with the dispensing machine to select a DVD to be dispensed by the machine. The user interface control system 224 can employ simple menus and a fixed set of keys for consumers to make their selections, it can employ break-resistant touch screens, or it can employ a combination of both. Once a selection has been made, the consumer then merely inserts his/her magnetically encoded dispense activation card into the card reader 240 positioned at the front of the dispensing machine 230 and, in response, the machine will dispense the selected DVD without the need for further input by the consumer.

When the selection has been made, the selector arm 256, in connection with the picker 264, grabs and causes the selected DVD to be dispensed, preferably in less than twenty seconds. The specific user request made at the machine (e.g., renting a new movie or payment by credit card) is then sent via satellite feed or DSL or cable modem or via the Internet to a centralized system office in real-time for processing. Such a procedure ensures accurate and rapid handling of every user request as well as secure billing to any credit card account of the consumer.

When a consumer returns a DVD to a dispensing machine, he/she, if he/she is a member, can insert the membership card into the card reader on the front of the machine, enters his/her personal identification number when prompted and inputs the appropriate additional commands to initiate the return process. The consumer then inserts the DVD into the dispensing/receiving receptacle on the front of the machine. A bar code reader, which may optionally be the same as the second sensor 370 attached to the selector arm 256, then scans the returned DVD for its unique code and the selector arm 256 and the picker 264 attached thereto place the returned DVD back into the physical inventory of the machine to await the next rental of that DVD.

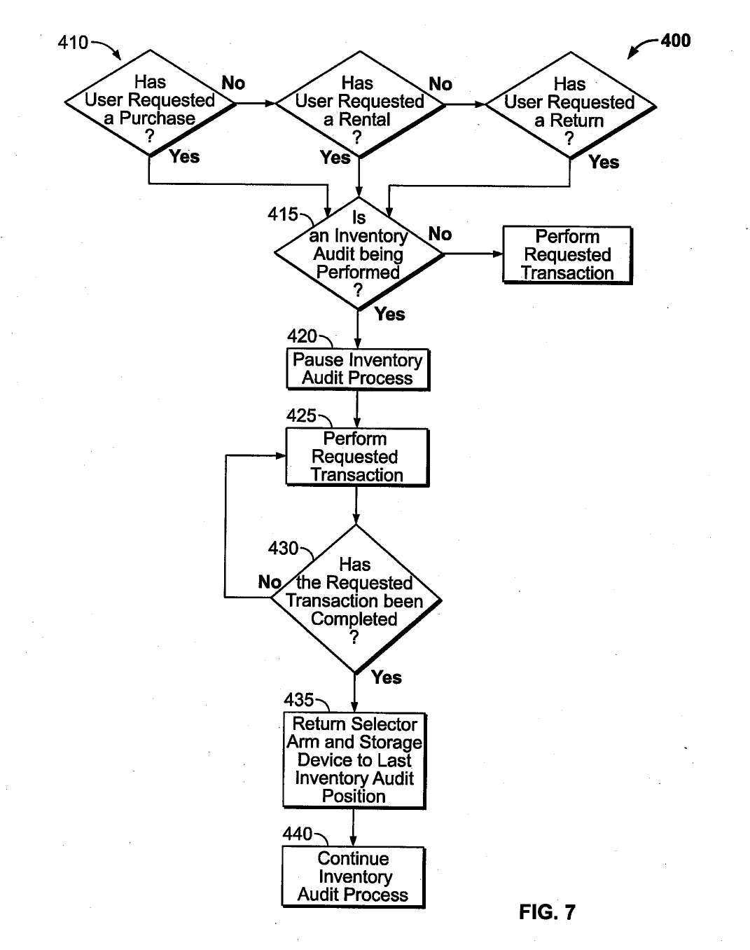

As shown in FIG. 7, during the inventory auditing process 500, the user interface 234 which typically includes a touch screen or keypad 242, remains available for use by a customer. A method for pausing the inventory auditing process 400 is shown in FIG. 7. Using the user interface 234, a customer may initiate a transaction, as shown in step 410, which requires the use of the selector arm 256, such as a video rental, purchase or return. In step 415, the program determines whether an inventory audit is being performed at the time of the transaction request. If an inventory audit is being performed, the inventory auditing program, in response to the requested transaction, instructs the processor to pause the execution of the inventory audit program, as shown in step 420.

In response to the requested transaction, the inventory audit program may first assess whether an article has been removed from its compartment. The program may do so in a number of ways, for example, by receiving a signal indicating the position or last movement of the picker 264 or by assessing whether the program has more recently instructed the picker to remove an article from its storage compartment or to replace an article to its storage compartment. If an article has been removed from its compartment the program instructs the picker 264 to return the article to its storage compartment prior to permitting the execution of the requested transaction. The various components of the machine, including the selector arm 256, perform the transaction requested by the user as described above in detail, which may require the second sensor 270 to read information from the returned or requested video and may further require transport of the returned or requested video, as shown in step 425.

When the transaction is completed, the inventory auditing process is resumed as shown in steps 430, 435 and 440. The inventory auditing program directs motors 251 and 262 to position the selector arm 256 adjacent the compartment with which it was aligned when the inventory auditing process was paused. The inventory audit program resumes at the point at which it was paused and continues to scan each storage compartment as described above until completion of the program. When all storage compartments have been audited, the inventory audit program stops.

What is claimed is:

1. A method of performing an inventory audit of a plurality of articles contained in an article dispensing machine, each article having a unique identifier and unique location, while permitting a user to transact with the article dispensing machine comprising the steps of:
initiating an inventory auditing process wherein the unique identifier and location of each article are determined;
permitting a user to initiate a transaction for at least one of a return, rental, or purchase of an article;
automatically pausing the inventory auditing process in response to the user transaction request;
performing the transaction requested by the user; and
resuming the inventory auditing process when the user transaction is complete.

2. The method of claim 1, further comprising the step of recording the unique identifier and location of each article.

3. The method of claim 1, further comprising the step of comparing the unique identifier and location of each article to a pre-existing database.

4. The method of claim 1, wherein initiating an inventory auditing process is triggered automatically by a condition.

5. The method of claim 4, wherein the condition is the passage of a predetermined number of hours.

6. The method of claim 4, wherein the condition is occurrence of a predetermined number of rentals.

7. The method of claim 4, wherein the condition is a startup of a computer operating system.

8. The method of claim 4, wherein the condition is a request from a central server in communication with the article vending machine.

9. A method of performing an inventory audit of a plurality of articles contained in an article dispensing machine while permitting a user to transact with the article dispensing machine comprising the steps of:
initiating an inventory auditing process wherein the inventory auditing process comprises using a first sensor attached to a selector arm to detect the presence of an article housed in the article dispensing machine and using a second sensor to read information from the plurality of articles housed in the article dispensing machine;
permitting a user to initiate a transaction that uses at least one of the sensor or the selector arm;
automatically pausing the inventory auditing process in response to the user transaction request;
performing the transaction requested by the user; and
resuming the inventory auditing process and using the second sensor, reading information from the articles that were not read prior to pausing the inventory auditing process.

10. The method of claim 9, wherein the inventory auditing process is controlled by an inventory auditing program and the inventory auditing program is run as a background process.

11. The method of claim 9, wherein the user transaction comprises at least one of returning an article, renting an article or purchasing an article.

12. The method of claim 9, wherein the first sensor comprises an optical sensor.

13. The method of claim 9, wherein the first sensor comprises a radio frequency sensor.

14. The method of claim 9, further comprising the step of storing the information read from the article in a database.

15. The method of claim 14, wherein the inventory auditing process further comprises determining the location of the article and storing the location of the article in the database.

16. The method of claim 15, wherein the step of determining the location of the article is performed by at least one motor.

17. The method of claim 9, further comprising the step of comparing the information read from the article with information in a pre-existing database.

18. The method of claim 17, wherein the inventory auditing process further comprises sensing the location of the article and storing the location of the article in the database.

19. The method of claim 9, wherein the step of performing the transaction requested by the user comprises transferring at least one of the articles by a selector arm that grips the one of the articles and moves the one of the articles from a first location to a second location.

20. An article vending machine having an inventory of articles comprising:
a user interface;
a plurality of articles housed in the article vending machine;
means for auditing the inventory of articles comprising an inventory auditing program;
means for automatically pausing the inventory auditing program in response to a customer input to the user interface wherein the customer input is a request to perform a transaction during execution of the inventory auditing program.

21. The article vending machine of claim 20, further comprising a database for storing the information attached to each article and the location of the article.

22. The article vending machine of claim 20, wherein the means for auditing the inventory of articles further comprises a first sensor for detecting the presence of an article, a second sensor for sensing information attached to each article; and a means for correlating the information attached to the article with the location of the article.

23. The article vending machine of claim 22, further comprising a means for aligning the first sensor with each article.

24. The article vending machine of claim 23, wherein the means for aligning the first sensor with each article comprises a selector arm mounted to a vertical axis and driven by a motor.

25. The article vending machine of claim 20, wherein the customer input request to perform a transaction is at least one of a request to rent, purchase or return an article.
